(19) United States
(12) Patent Application Publication
(10) Pub. No.: US 2026/0357998 A1
(43) Pub. Date: Nov. 12, 2026

(54) ADJUSTABLE FAN FOR A COOKING APPLIANCE

(71) Applicant: Haier US Appliance Solutions, Inc., Wilmington, DE (US)

(72) Inventor: Bagawathkumar Chellappan, Prospect, KY (US)

(21) Appl. No.: 19/200,802

(22) Filed: May 7, 2025

(51) Int. Cl. F24C 15/20; F04D 27/00; F04D 29/26; F04D 29/40; G05G 1/02; H05B 6/64

(52) U.S. Cl. CPC F24C 15/2071; F04D 27/00; F04D 29/26; F04D 29/403; F24C 15/2021; F24C 15/2035; G05G 1/025; H05B 6/64

(57) ABSTRACT

A cooking appliance includes a casing defining a cooking chamber and a circulation conduit including an inlet and outlet. Furthermore, the appliance includes a door mounted to the casing and a fan assembly positioned within the conduit. The assembly includes a discharge housing with discharge ports. Furthermore, the assembly includes a fan housing including an outlet. The fan housing is mounted within the discharge housing and is rotatable to align the outlet with a selected discharge port. Furthermore, the assembly includes an impeller rotatably mounted within the fan housing. Rotation of the impeller circulates air through the outlet of the fan housing and the selected discharge port. Moreover, the assembly includes a drive wheel coupled to the fan housing that includes a circumferential surface. Additionally, the assembly includes a tension member that engages the surface of the wheel, whereby movement of the member rotates the wheel and the fan housing.

### FIELD

The present subject matter relates generally to cooking appliances, and more particularly to fans in over-the-range cooking appliances.

### BACKGROUND

Over-the-range cooking appliances, such as over-the-range microwave appliances, are generally mounted above a cooktop of an oven range appliance. In addition to providing for heating of food and beverage items, certain over-the-range microwave appliances include a circulation system. When activated, the circulation system can draw fumes, smoke, grease, and/or steam away from the cooktop of the oven range appliance. Circulation systems generally include a fan for drawing a flow of air into the circulation system and a grease filter for trapping grease entering the circulation system.

Over-the-range microwave appliances generally have a radial blower fan that can be adjusted to recirculate or externally vent through an air vent. The installer of the microwave appliance can adjust the blower fan by removing certain parts to access and remove the radial blower fan, in order to reposition the fan. In other words, to switch venting directions after installation of the microwave appliance, the microwave appliance needs to be uninstalled and then reinstalled with the fan repositioned to change the venting direction. At times, installers may overlook ducting in the home and install the microwave appliance without properly orienting the blower fan to the functional position. This can lead to the failure of the magnetron and the cooking air not being vented in the desired direction for the consumer.

Accordingly, a cooking appliance with features for adjusting the circulation of the cooking appliance without uninstalling and reinstalling the fan would be useful.

### BRIEF DESCRIPTION

Aspects and advantages of the invention will be set forth in part in the following description, or may be apparent from the description, or may be learned through practice of the invention.

In one exemplary aspect of the present disclosure, a cooking appliance is provided. The cooking appliance includes a casing. The casing defines a cooking chamber for receipt of food items for cooking. Additionally, the casing defines a circulation conduit. The circulation conduit includes an inlet and an outlet. Furthermore, the cooking appliance includes a door. The door is mounted to the casing to permit selective access to the cooking chamber. Moreover, the cooking appliance includes an adjustable fan control knob. The fan control knob is positioned on an exterior of the cooking appliance. Additionally, the cooking appliance includes a fan assembly. The fan assembly is positioned within the circulation conduit. The fan assembly includes a discharge housing. The discharge housing includes a plurality of discharge ports. Furthermore, the fan assembly includes a fan housing. The fan housing includes an outlet. Moreover, the fan housing is mounted within the discharge housing. Additionally, the fan housing is selectively rotatable within the discharge housing to align the outlet with a selected one of the plurality of discharge ports. Furthermore, the fan assembly includes an impeller. The impeller is rotatably mounted within the fan housing. Rotation of the impeller circulates air through the outlet of the fan housing and the selected one of the plurality of discharge ports. Moreover, the fan assembly includes a drive wheel. The drive wheel includes a groove defined circumferentially around the drive wheel. Additionally, a surface of the drive wheel is positioned within the groove. Furthermore, the drive wheel is coupled to the fan housing. Moreover, the fan assembly includes a tension member. The tension member is connected between the fan control knob and the drive wheel and engages the surface of the drive wheel. Adjustment of the fan control knob moves the tension member thereby rotating the drive wheel and the fan housing.

In another exemplary aspect of the present disclosure, a cooking appliance is provided. The cooking appliance includes a casing. The casing defines a cooking chamber for receipt of food items for cooking. Additionally, the casing defines a circulation conduit. The circulation conduit includes an inlet and an outlet. Furthermore, the cooking appliance includes a door. The door is mounted to the casing to permit selective access to the cooking chamber. Moreover, the cooking appliance includes a fan assembly. The fan assembly is positioned within the circulation conduit. The fan assembly includes a discharge housing. The discharge housing includes a plurality of discharge ports. Furthermore, the fan assembly includes a fan housing. The fan housing includes an outlet. Moreover, the fan housing is mounted within the discharge housing. Additionally, the fan housing is selectively rotatable within the discharge housing to align the outlet with a selected one of the plurality of discharge ports. Furthermore, the fan assembly includes an impeller. The impeller is rotatably mounted within the fan housing. Rotation of the impeller circulates air through the outlet of the fan housing and the selected one of the plurality of discharge ports. Moreover, the fan assembly includes a drive wheel. The drive wheel includes a surface that extends circumferentially around the drive wheel. Furthermore, the drive wheel is coupled to the fan housing. Moreover, the fan assembly includes a tension member. The tension member engages the surface of the drive wheel. Movement of the tension member rotates the drive wheel and the fan housing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example cooking appliance according to an example embodiment of the present subject matter mounted to a kitchen cabinet above an oven range appliance.

FIG. 2 provides a side, section view of the example cooking appliance and the oven range appliance of FIG. 1.

FIG. 3 provides a perspective view of a fan assembly of a cooking appliance, such as the example cooking appliance of FIG. 1.

FIG. 4 provides an exploded perspective view of the fan assembly of FIG. 3.

FIG. 5 provides a front view of the fan assembly of FIG. 3.

FIG. 6 provides a side view of the fan assembly of FIG. 3.

FIG. 7 provides a perspective view of an example embodiment of an example cooking appliance with the fan assembly of FIG. 3 in a first position.

FIG. 8 provides a perspective view of an example embodiment of an example cooking appliance with the fan assembly of FIG. 3 in a second position.

FIG. 9 provides a perspective view of an example embodiment of an example cooking appliance with the fan assembly of FIG. 3 in a third position.

FIG. 10 provides a front cross-sectional view of the fan assembly of FIG. 3.

FIG. 11 provides a close-up front cross-sectional view of the fan assembly of FIG. 3.

FIG. 12 provides a perspective view of an example cooking appliance and the fan assembly of FIG. 3 with a tension member connected between a drive wheel of the fan assembly and an adjustable fan control knob.

FIG. 13 provides a perspective view of the fan assembly of FIG. 3 with the tension member connected between the drive wheel of the fan assembly and the adjustable fan control knob.

FIG. 14 provides a perspective view of the fan assembly of FIG. 3 with the tension member connected to the drive wheel.

FIG. 15 provides a close-up perspective view of the drive wheel of the fan assembly of FIG. 3.

FIG. 16 provides a close-up perspective view of an example tension member guide of the fan assembly of FIG. 3.

FIG. 17 provides a perspective view of the fan assembly of FIG. 3 with a motor drive assembly mounted to the fan assembly.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

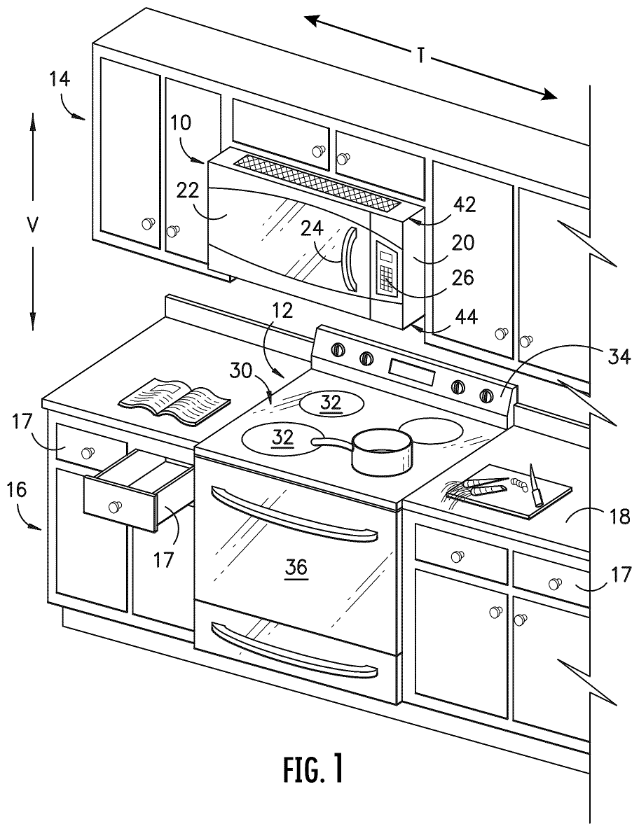

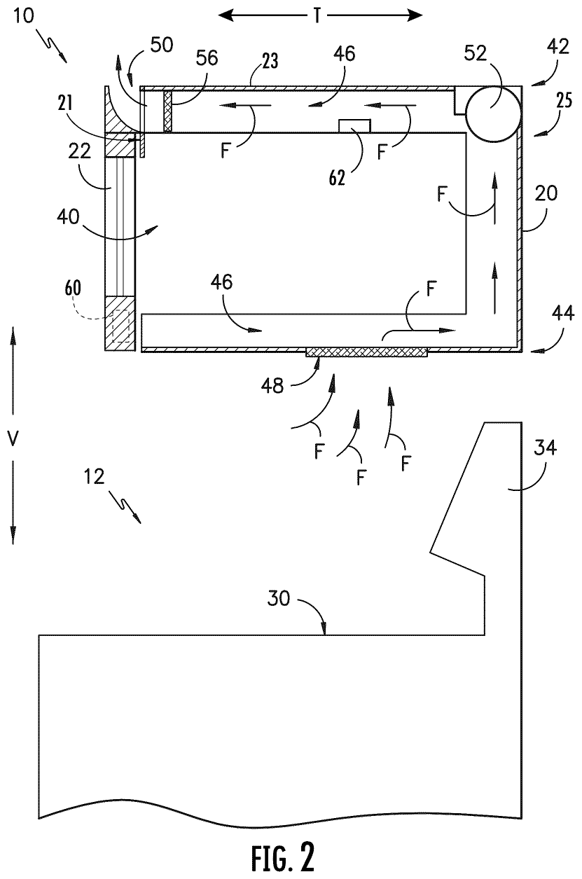

FIG. 1 provides a perspective view of a cooking appliance, described herein as a microwave appliance 10, according to an example embodiment of the present subject matter. Microwave appliance 10 generally defines a vertical direction V, a lateral direction L, and a transverse direction T (FIG. 2), each of which is mutually perpendicular, such that an orthogonal coordinate system is generally defined. Microwave appliance 10 is shown in FIG. 1 mounted to an upper set of kitchen cabinets 14 above an oven range appliance 12, e.g., along the vertical direction V. Microwave appliance 10 shown in FIG. 1 is commonly referred to as an over-the-range microwave. It should be understood that, in alternative example embodiments, the present subject matter may be used in any other suitable cooking appliance, such as an oven appliance or any other suitable microwave appliance.

As discussed above, microwave appliance 10 is mounted to upper set of kitchen cabinets 14. Upper set of kitchen cabinets 14 is positioned above a base set of kitchen cabinets 16, e.g., along the vertical direction V. Base set of kitchen cabinets 16 includes countertops 18 and drawers 17. Microwave appliance 10 is positioned above base set of kitchen cabinets 16, e.g., along the vertical direction V. Oven range appliance 12 is received within base set of kitchen cabinets 16 below microwave appliance 10. In particular, a cooking surface 30 of oven range appliance 12 is positioned, e.g., directly, below microwave appliance 10 along the vertical direction V. Microwave appliance 10 can include features such as an air handler or fan assembly 52 (FIG. 2) that can draw cooking vapors and/or smoke away from cooking surface 30 and out of the kitchen containing microwave and oven range appliances 10 and 12.

Microwave appliance 10 is configured for receipt of food items for cooking. In particular, microwave appliance 10 includes a cabinet or casing 20 and a door 22 that permits selective access to an interior of microwave appliance 10 and casing 20. Door 22 includes a handle 24 that a user can pull to open door in order to insert food items into microwave appliance 10. Microwave appliance 10 also includes controls 26 that permit a user to make selections for cooking of food items, e.g., a duration of a cooking cycle of microwave appliance 10 and/or a power setting for the cooking cycle of microwave appliance 10.

As discussed above, oven range appliance 12 includes cooking surface 30. Cooking surface 30 includes heated portions 32 that may be heated by heating elements (not shown), e.g., electrical resistive heating elements, gas burners, induction heating elements, and/or any other suitable heating element or combination of heating elements. Oven range appliance 12 also includes a door 36 that permits access to a heated compartment (not shown) of oven range appliance 12, e.g., for cooking or baking of food items therein. A control panel 34 of oven range appliance 12 can permit a user to make selections for cooking of food items, e.g., a duration of a cooking cycle of oven range appliance 12 and/or a power setting for the cooking cycle of oven range appliance 12.

FIG. 2 provides a side, section view of microwave appliance 10 and oven range appliance 12. As may be seen in FIG. 2, casing 20 extends between a top portion 42 and a bottom portion 44, e.g., along the vertical direction V. Thus, top and bottom portions 42 and 44 of casing 20 are spaced apart from each other, e.g., along the vertical direction V. In particular, casing 20 may include a front wall 21, a top wall 23, and a back wall 25 as will be described further hereinbelow. Casing 20 may generally define a cooking chamber 40 configured for receipt of food items for cooking. Door 22, which may be positioned adjacent to front wall 21 of casing 20 of microwave appliance 10, permits selective access to cooking chamber 40 of casing 20. In particular, door 22 of microwave appliance 10 is selectively adjustable between an open position (not shown) and a closed position (FIGS. 1 and 2). In the closed position, door 22 of microwave appliance 10 hinders access to cooking chamber 40 of casing 20. Conversely, door 22 of microwave appliance 10 permits access to cooking chamber 40 of casing 20 in the open position. A user can pull on handle 24 of door 22 of microwave appliance 10 in order to shift door 22 from the closed position shown in FIG. 2 to the open position.

Casing 20 also defines a circulation passage or conduit 46. Circulation conduit 46 has an inlet 48 and an outlet 50. Circulation conduit 46 extends between inlet 48 and outlet 50. Inlet 48 of circulation conduit 46 is positioned at or adjacent bottom portion 44 of casing 20, e.g., such that inlet 48 of circulation conduit 46 faces cooking surface 30 of oven range appliance 12. Conversely, outlet 50 of circulation conduit 46 is positioned at or adjacent top portion 42 of casing 20, e.g., such that outlet 50 of circulation conduit 46 faces away from cooking surface 30 of oven range appliance 12. Thus, inlet 48 and outlet 50 of circulation conduit 46 are spaced apart from each other, e.g., along the vertical direction V.

Microwave appliance 10 may include a fan assembly 52, such as an axial fan or a radial fan. Fan assembly 52 may be positioned within or adjacent circulation conduit 46. Fan assembly 52 may draw or urge a flow of air (shown with arrows F) through circulation conduit 46 when fan assembly 52 is in an activated state. Conversely, fan assembly 52 may not draw or urge flow of air F through circulation conduit 46 when fan assembly 52 is in a deactivated state. When fan assembly 52 is in the activated state, flow of air F enters circulation conduit 46 at, or through, inlet 48 of circulation conduit 46. In the present example embodiment, flow of air F is directed through circulation conduit 46 to outlet 50, and flow of air F can exit circulation conduit 46 at outlet 50 of circulation conduit 46. As described above, fan assembly 52 is described in a recirculation orientation where flow of air F is directed through circulation conduit 46 to outlet 50, however, fan assembly 52 may be configurable to direct flow of air F in other desired directions. Fan assembly 52, and other possible orientations of fan assembly 52 will be described in further detail hereinbelow.

Microwave appliance 10 may also include an air filter 56. Air filter 56 may be mounted to casing 20 such that flow of air F within circulation conduit 46 passes through air filter 56 when fan assembly 52 is in the activated state. In the example embodiment shown in FIG. 2, air filter 56 is positioned within circulation conduit 46 at outlet 50 of circulation conduit 46. It should be understood that in alternative example embodiments, air filter 56 may be positioned at any other suitable location on microwave appliance 10.

As may be seen in FIG. 2, microwave appliance 10 includes a controller 60. Operation of microwave appliance 10 is regulated by controller 60. Controller 60 is operatively coupled or in communication with various components of microwave appliance 10, including controls 26. In response to user manipulation of controls 26, controller 60 operates the various components of microwave appliance 10 to execute selected cycles and features.

Controller 60 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 60 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Controls 26 and other components of microwave appliance 10 may be in communication with controller 60 via one or more signal lines or shared communication busses.

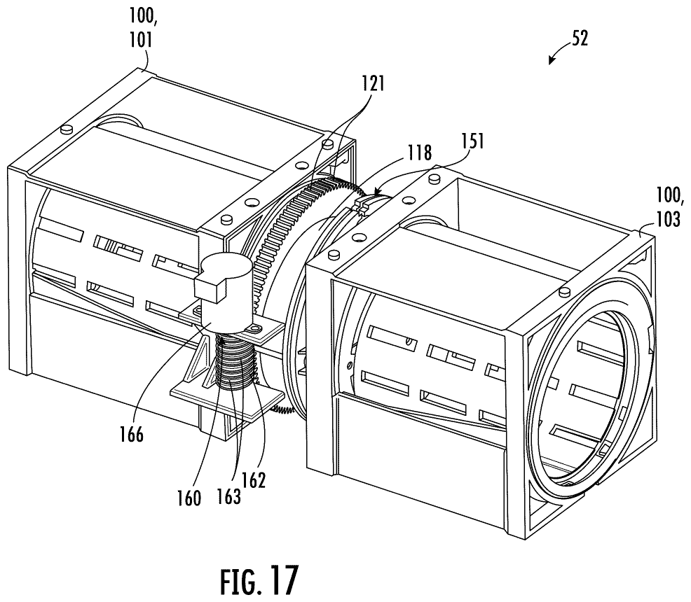

Microwave appliance 10 also includes a magnetron 62. Magnetron 62 is configured for generating microwaves and directing such microwaves towards or into cooking chamber 40 of casing 20. Magnetron 62 can be positioned at any suitable location within microwave appliance 10. For example, magnetron 62 may be mounted to casing 20, e.g., at or adjacent top portion 42 of casing 20, such that magnetron 62 is positioned at or adjacent cooking chamber 40 of casing 20. Controller 60 can selectively activate magnetron 62, e.g., in order to heat food or beverage items in cooking chamber 40, based at least in part on an activation signal received from controls 26. Further, controller 60 may also be in operative communication with fan assembly 52. For example, controller 60 may be in operative communication with a motor 166 of a motor drive assembly 160 (FIG. 17) coupled to fan assembly 52. Thus, controller 60 may selectively adjust fan assembly 52, e.g., by motor 166, between the activated and deactivated states in order to regulate the flow of air F through circulation conduit 46.

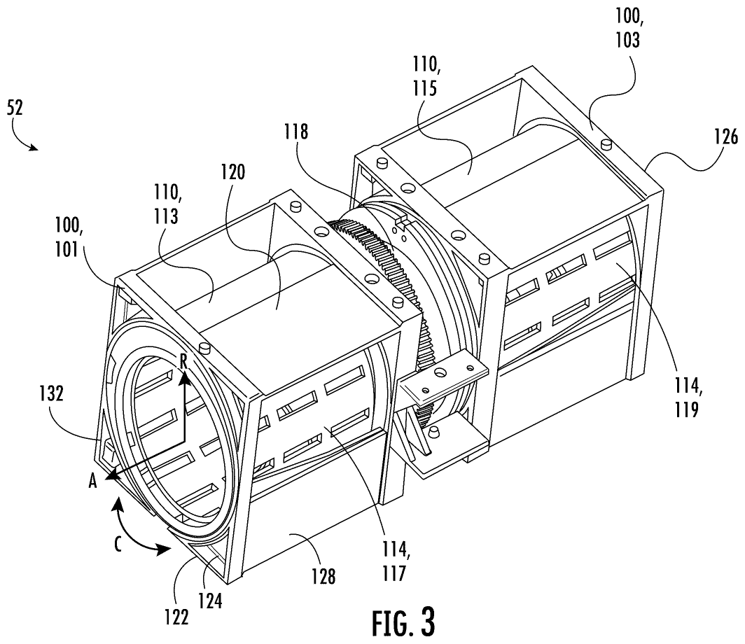

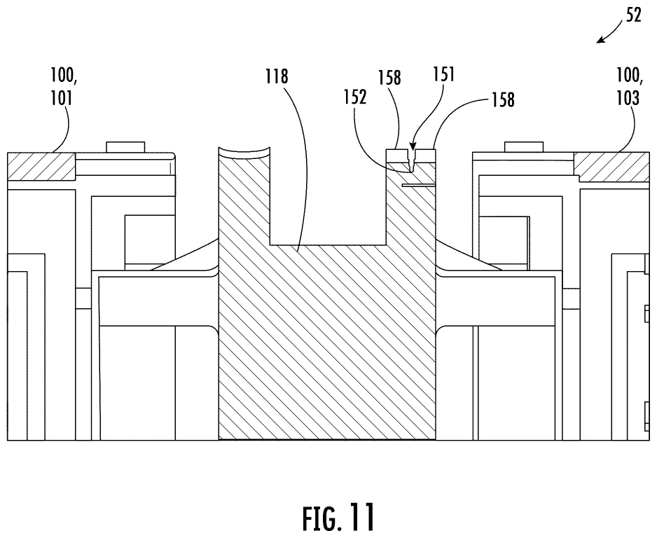

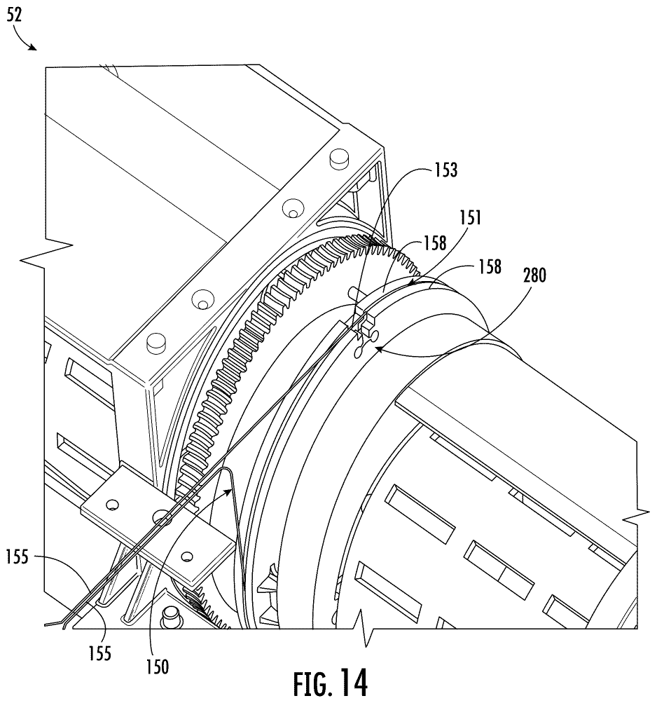

Illustrated in FIGS. 3 through 17 is an example embodiment of fan assembly 52 for use with a cooking appliance, such as microwave appliance 10. While described herein as used with microwave appliance 10, it should be appreciated that additionally, or alternatively, fan assembly 52 may be used in other cooking appliances such as oven appliances and/or other suitable appliances or structures such as heating, ventilation, and air conditioning systems (HVAC) or vent hood appliances.

As best illustrated in FIGS. 3 through 9, fan assembly 52 may include a discharge housing 100. In general, discharge housing 100 may extend between a top side 120, a bottom side 122, a first side wall 124, a second side wall 126, a front side 128, and a back side 132, e.g., discharge housing 100 may be generally rectangular in shape. Discharge housing 100 may be divided into two sections in the lateral direction L, e.g., discharge housing 100 may be two independent sections, a first discharge housing section 101 and a second discharge housing section 103, separated by a drive wheel 118 as described below. As such, drive wheel 118 may be positioned or sandwiched between first discharge housing section 101 and second discharge housing section 103 of discharge housing 100. In general, discharge housing 100 may be symmetrical across drive wheel 118 in order to provide modularity of fan assembly 52. However, while described herein as having two independent sections, it should be appreciated that, in some embodiments, discharge housing 100 may include a single section, e.g., first discharge housing section 101. In this respect, drive wheel 118 may be mounted to the single discharge housing section, e.g., to an outside portion thereof.

According to some example embodiments, discharge housing 100 may generally define a plurality of discharge ports, e.g., a first discharge port 102, a second discharge port 104, and a third discharge port 106. In example embodiments, the plurality of discharge ports 102, 104, and 106 includes three discharge ports, first discharge port 102, second discharge port 104, and third discharge port 106, facing in different directions. In general, the plurality of discharge ports 102, 104, and 106 may be oriented in any suitable direction. For example, first discharge port 102 may be defined in front side 128 of discharge housing 100 (e.g., the first discharge port 102 may generally face forward along the transverse direction T), second discharge port 104 may be defined in top side 120 of discharge housing 100 (e.g., the second discharge port 104 may generally face upward along the vertical direction V), and third discharge port 106 may be defined in back side 132 of discharge housing 100 (e.g., the third discharge port 106 may generally face backward along the transverse direction T). In some embodiments, the plurality of discharge ports 102, 104, and 106 may each be defined as pairs of discharge ports, such as one port on each section of discharge housing 100 forming pairs of discharge ports such that discharge housing 100 is symmetrical across drive wheel 118. However, in embodiments in which the discharge housing 100 includes a single section, the discharge housing 100 may define only one of each discharge port 102, 104, and 106.

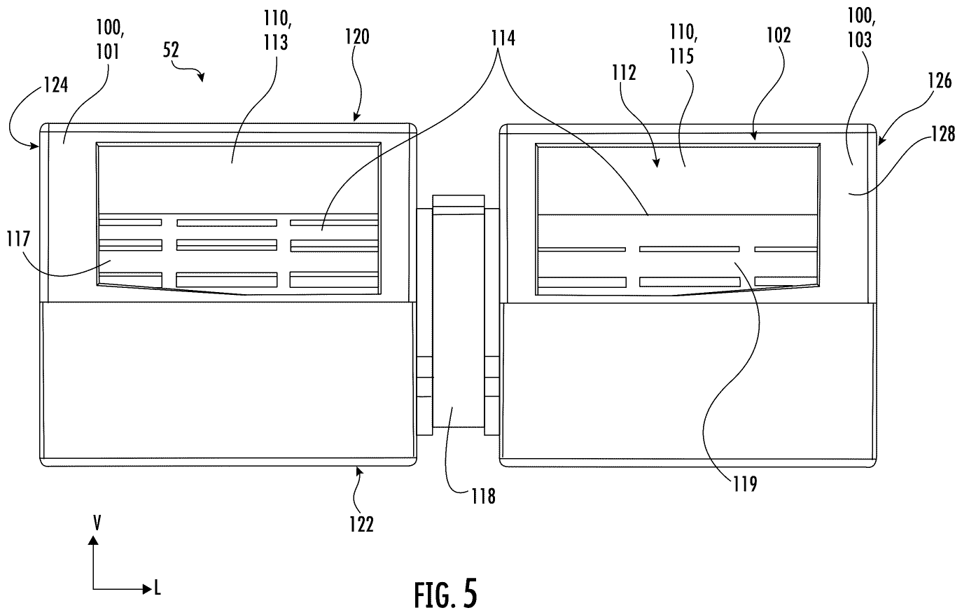

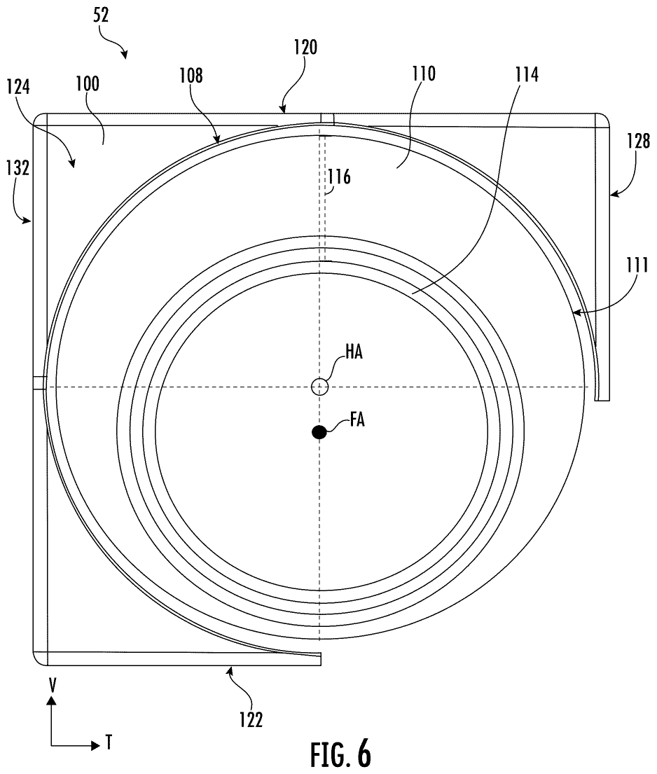

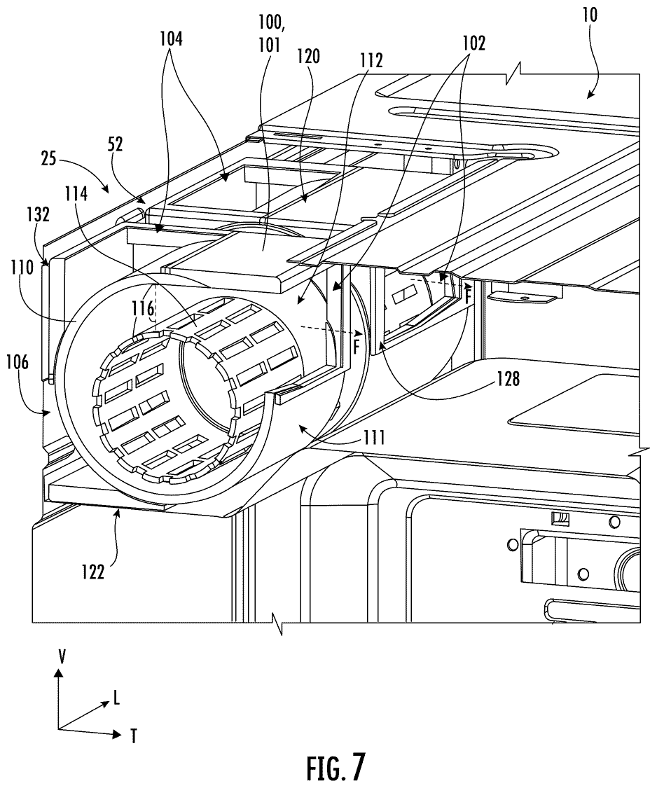

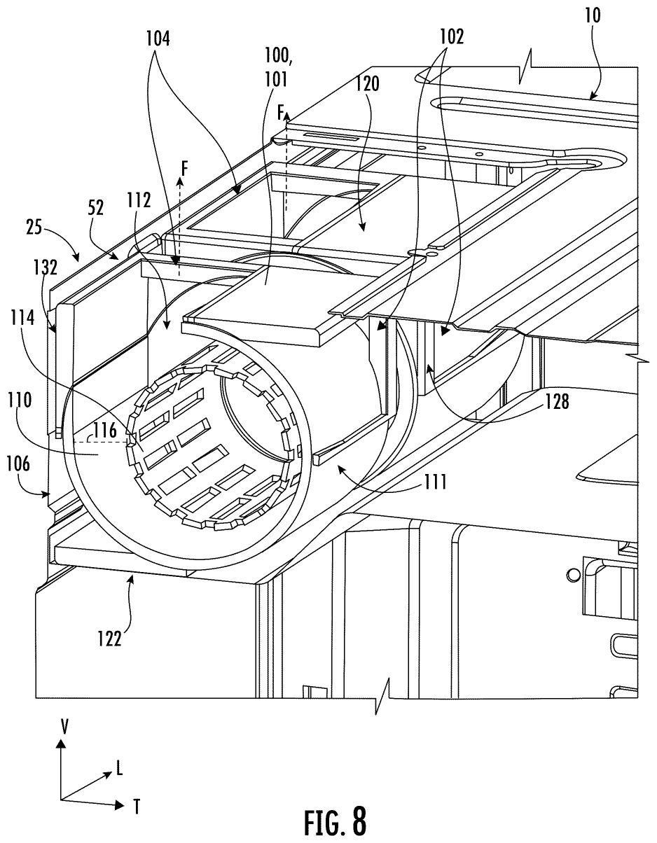

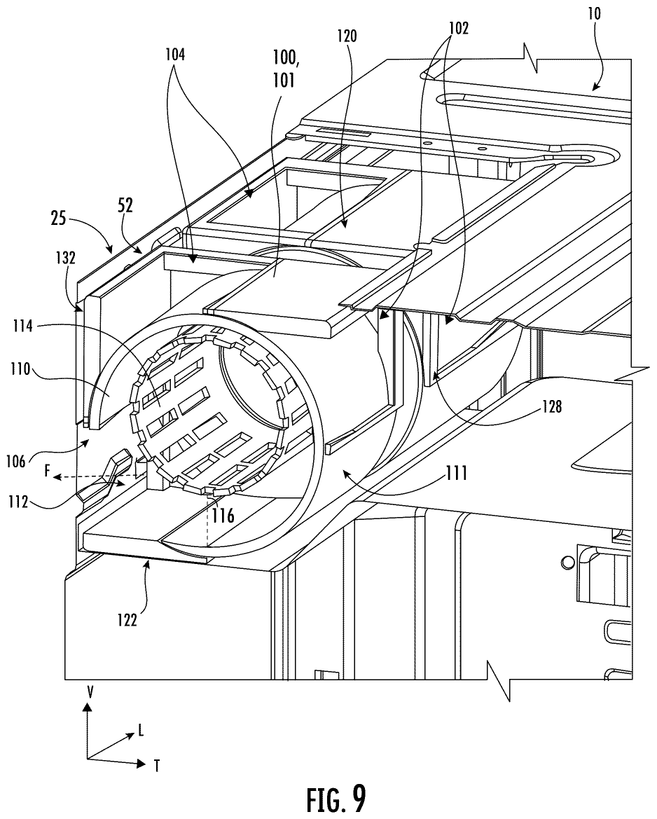

As best illustrated in FIGS. 3 and 5, a fan housing 110 may be mounted within discharge housing 100, e.g., fan housing 110 may include two sections, a first fan housing section 113 and a second fan housing section 115, one on each side of drive wheel 118, e.g., one in each section, first discharge housing section 101 and second discharge housing section 103 respectively, of discharge housing 100. In particular, as best illustrated in FIG. 6, discharge housing 100 may include an opening 108, e.g., a cylindrically shaped opening in each of first side wall 124 and second side wall 126 of discharge housing 100. Fan housing 110 may include an outer surface 111 and may be cylindrical, and concentric with opening 108 of discharge housing 100, such that fan housing 110 fits within opening 108 in both of the transverse direction T and vertical direction V. In other words, fan housing 110 may be laterally, in the lateral direction L, positioned within, and rotatable within, opening 108 of the discharge housing 100. For example, in the present example embodiment, fan housing 110 may be selectively rotatable within discharge housing 100. In particular, fan housing 110 may include an outlet 112, in each respective section within discharge housing 100, configured to align with a selected one of the plurality of discharge ports 102, 104, and 106. For example, fan housing 110 may be rotatable between a first position (as seen in FIG. 7), wherein outlet 112 is aligned with first discharge port 102 and flow of air F is directed through first discharge port 102, a second position (as seen in FIG. 8), wherein outlet 112 is aligned with second discharge port 104 and flow of air F is directed through second discharge port 104, and a third position (as seen in FIG. 9), wherein outlet 112 is aligned with third discharge port 106 and flow of air F is directed through third discharge port 106. Notably, fan housing 110 may be rotatable within discharge housing 100 while the discharge housing 100 and fan housing 110 are installed within microwave appliance 10. In example embodiments in which fan housing 110 is flexible, fan housing 110 may compress during rotation and spring back to its original position in order to align with the desired discharge port.

Furthermore, in some example embodiments, fan housing 110 may be any other suitable shape, such as a cube, cuboid, prism, etc. Furthermore, fan housing 110 may be made, at least partially, from any suitable rigid or flexible fire-retardant metal material, such as steel, nickel, titanium, iron, or some metal alloy combination thereof. Additionally, the fan housing 110 may be made, at least partially, using hot-rolled metal, cold-rolled metal, cast iron, and/or stainless steel.

Referring again to FIGS. 3 through 9, in general, fan housing 110 may include an impeller 114, e.g., in each section of fan housing 110. For example, a first impeller 117 may be positioned in first fan housing section 113 and a second impeller 119 may be positioned in second fan housing section 115. In particular, impeller 114 may be rotatably mounted within fan housing 110 such that impeller 114 may be configured to circulate air through outlet 112 of fan housing 110 and the selected one of the plurality of discharge ports 102, 104, and 106. For example, impeller 114 may be mechanically coupled to drive wheel 118 which, as will be described below, is rotatable by a tension member and, in some embodiments, may alternatively be rotatable by a motor. The drive wheel 118 is generally configured to rotate impeller 114 within fan housing 110. As best illustrated in FIG. 6, impeller 114 may be mounted within fan housing 110 on a fan axis FA parallel to, and spaced apart from, a housing axis HA of the fan housing. As such, an inside gap 116 of fan housing 110 from impeller 114 may be non-uniform and progressively increasing towards outlet 112 of the fan housing 110. For example, as explained above, fan housing 110 may be selectively rotatable within discharge housing 100 between the plurality of discharge ports 102, 104, and 106, and offsetting fan axis FA from housing axis HA may thereby keep inside gap 116 of fan housing 110 from impeller 114 non-uniform and progressively increasing towards outlet 112 of fan housing 110 with respect to the selected one of the plurality of discharge ports 102, 104, and 106.

As described above, fan housing 110 may be rotatable between a first position in which outlet 112 is aligned with first discharge port 102, a second position in which outlet 112 is aligned with second discharge port 104, and a third position where outlet 112 is aligned with third discharge port 106. As illustrated in FIG. 7, fan housing 110 is shown in the first position, with outlet 112 aligned with first discharge port 102. When in the first position, flow of air F may flow out of first discharge port 102 of discharge housing 100 in the transverse direction T, such that air may be recirculated through circulation conduit 46 (e.g., as seen in FIG. 2). As illustrated in FIG. 8, fan housing 110 is shown in the second position, with outlet 112 aligned with second discharge port 104. When in the second position, flow of air F may flow out of second discharge port 104 of discharge housing 100 in the vertical direction V, such that flow of air F may flow out an external duct (not shown) extending in the vertical direction V. Further, as illustrated in FIG. 9, fan housing 110 is shown in the third position, with outlet 112 aligned with third discharge port 106. When in the third position, flow of air F may flow out of third discharge port 106 of discharge housing 100 in the transverse direction T, opposite the direction of the first position, such that flow of air F may flow out back side 132 of discharge housing 100 and out an external duct (not shown) in the transverse direction T.

According to some example embodiments, fan assembly 52 includes drive wheel 118. The drive wheel 118 generally defines a radial direction R (FIG. 3), an axial direction A (FIG. 3), and a circumferential direction C (FIG. 3) such that a cylindrical coordinate system is generally defined. The term “radial” refers to the relative direction that is substantially perpendicular to an axial centerline of drive wheel 118. The term “axially” refers to the relative direction that is substantially parallel and/or coaxially aligned to an axial centerline of drive wheel 118. The term “circumferentially” refers to the relative direction that extends around the axial centerline of drive wheel 118.

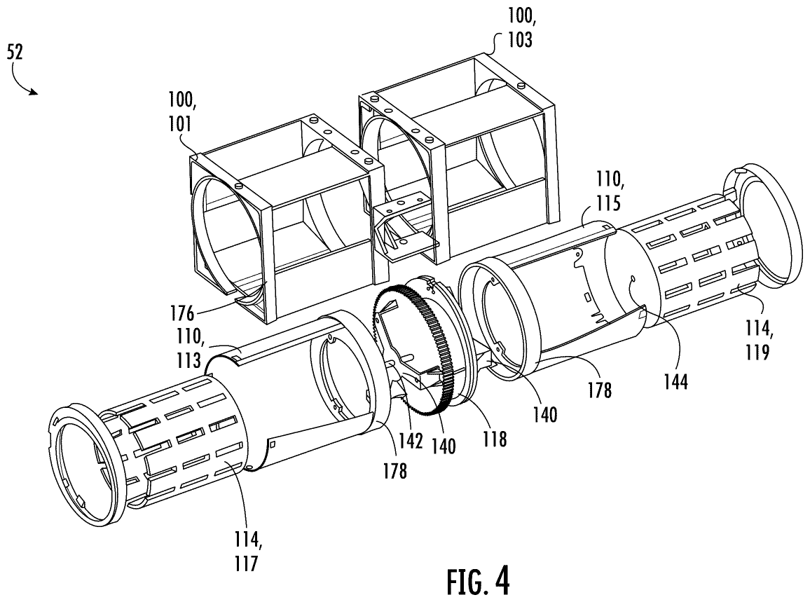

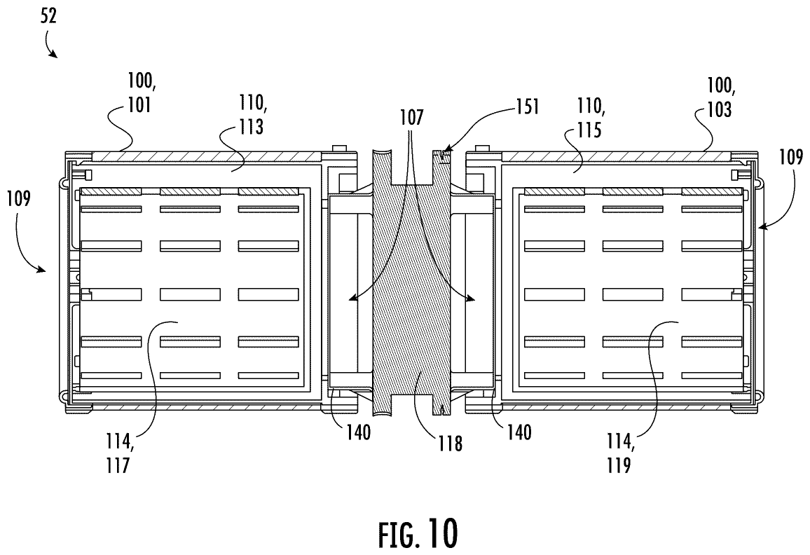

In general, fan housing 110 may be selectively rotatable within discharge housing 100 while installed within microwave appliance 10 by rotating drive wheel 118. For example, as best illustrated in FIGS. 4 and 10, drive wheel 118 may include a mounting structure 140 protruding from a side of the drive wheel 118. The fan housing 110 may be coupled to or mounted on the mounting structure 140 such as by receiving fasteners, e.g., bolts, through aligned pairs of holes of an inner fan housing ring 178 coupled to the fan housing 110 and the mounting structure 140. As illustrated, in some embodiments, drive wheel 118 may be positioned or sandwiched between first discharge housing section 101 and second discharge housing section 103. As such, drive wheel 118 may include two mounting structures 140, one protruding from opposite lateral sides of drive wheel 118, such that first fan housing section 113 and second fan housing section 115 may be coupled to the drive wheel 118. Additionally, a shaft 142 may protrude from the side of the drive wheel 118, such as from the lateral side as shown in FIG. 4. The shaft 142 may be received through the impeller 114, e.g., a shaft hole 144 thereof, and fixed to the impeller 114. In this respect, rotation of the drive wheel 118 also rotates the impeller 114. As illustrated, drive wheel 118 may include two shafts 142, one protruding from the opposite lateral sides of drive wheel 118 that the mounting structures 140 protrude from, such that first impeller 117 and second impeller 119 may be coupled to the drive wheel 118. While described herein as positioned/sandwiched between first discharge housing section 101 and second discharge housing section 103, it should be appreciated that, in some other embodiments, drive wheel 118 may be positioned at any other suitable location, such as at first side wall 124 or second side wall 126.

Referring to FIGS. 10 through 16, notably, in some example embodiments, drive wheel 118 may be rotatable, such as manually rotatable. For example, a user may adjust or move a fan control knob, such as fan control knob 260 of microwave appliance 10, which is connected to a tension member 150. Tension member 150 may be connected between and to drive wheel 118 and fan control knob 260. In this respect, adjustment or movement of the fan control knob 260 may move the tension member 150 which, in turn, rotates the drive wheel 118. As such, drive wheel 118 may include a contact surface 152. The contact surface 152 may extend circumferentially around the drive wheel 118. Tension member 150 may engage at least a portion of the contact surface 152 of drive wheel 118. For example, tension member 150 may be looped around a portion of drive wheel 118 and, as such, may contact a portion of the contact surface 152. The tension member 150 may be utilized to provide tension/tensile force to rotate drive wheel 118 and, thus, fan housing 110 and impeller 114. As such, movement of tension member 150 rotates drive wheel 118 and, thus, fan housing 110 and impeller 114. The tension member 150 may be any suitable tension member such as a rope, cable, chain, belt, and/or the like. However, while described herein as manually rotatable by a tension member, e.g., tension member 150, it should be appreciated that, in some other embodiments, drive wheel 118 may be automatically rotatable by a tension member. For example, tension member 150 may be connected between and to drive wheel 118 and a motor or motor driven actuator. In this respect, a user may operate a switch that electrically activates the motor, which, in turn, results in rotation of drive wheel 118.

According to some example embodiments, tension member 150 may be positioned within a groove 151 defined circumferentially around drive wheel 118. Groove 151 may be defined by a pair of radial side walls 158 extending circumferentially around drive wheel 118, and tension member 150 may be positioned between the pair of radial side walls 158, i.e., within groove 151, to inhibit tension member 150 from sliding off of drive wheel 118. The contact surface 152 described above may also be positioned within groove 151. In this respect, tension member 150 may engage the portion of the contact surface 152 described above within the groove 151. However, it should be appreciated that, in some embodiments, contact surface 152 may not be positioned within a groove. For example, tension member 150 may not be bounded by any walls while engaging contact surface 152.

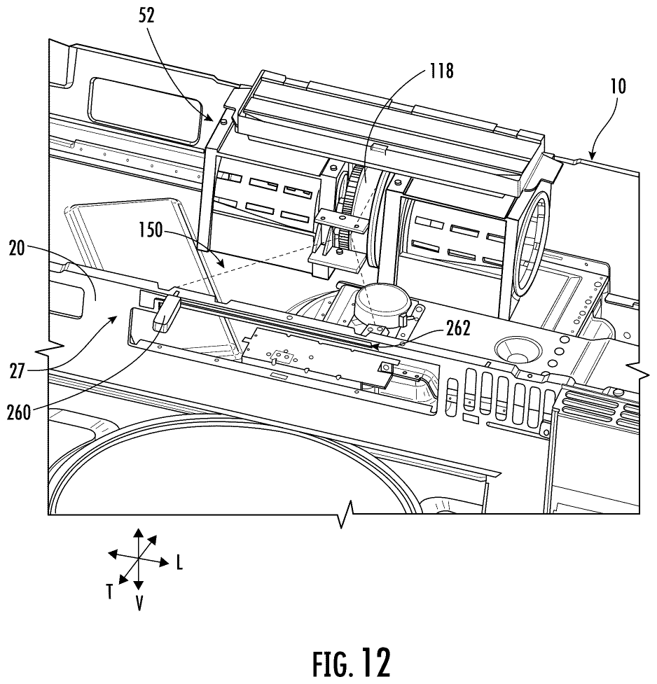

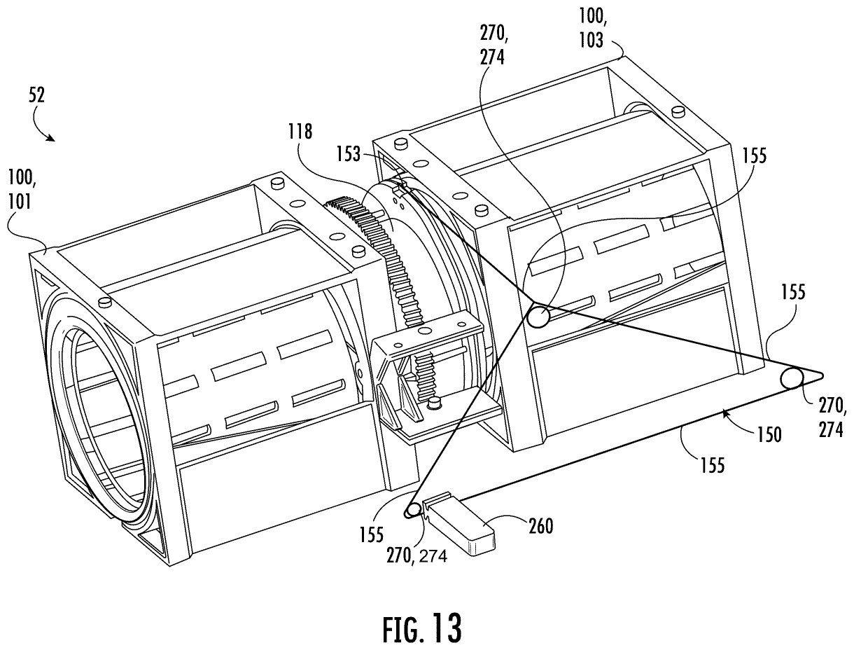

As best illustrated in FIGS. 12 and 13, in some embodiments, tension member 150 may be connected to fan control knob 260, e.g., positioned within a notch thereof, of microwave appliance 10. Additionally, fan control knob 260 may be positioned on an exterior 27 of microwave appliance 10, e.g., on front wall 21 of casing 20, for user ease of access. For example, as shown in FIG. 12, fan control knob 260 may be positioned above door 22 of microwave appliance 10 in the vertical direction V. However, it should be appreciated that the fan control knob 260 may be positioned in any other suitable location on the exterior 27 of microwave appliance 10, such as beside door 22 of microwave appliance 10, e.g., in the lateral direction L or below door 22 in the vertical direction V. Additionally, in some embodiments, it should be appreciated that the fan control knob 260 may be positioned behind an exterior panel/door (not shown) that may cover the fan control knob 260 for aesthetic purposes.

As described briefly above, the user may adjust/move the fan control knob 260. In some embodiments, for example, fan control knob 260 may be linearly slidable/slidable along a linear path, e.g., in the lateral direction L. For example, as shown in FIG. 12, a slide pathway 262 may be defined by casing 20 of microwave appliance 10 in a linear direction, e.g., lateral direction L. At least a portion of fan control knob 260 may be positioned at/on the slide pathway 262. Fan control knob 260 may be moveable/slidable, e.g., by the user, along the slide pathway 262, e.g., in the lateral direction L, between a plurality of positions. In this respect, since tension member 150 is connected to fan control knob 260, sliding of fan control knob 260 along the linear path, e.g., along slide pathway 262, moves the tension member 150 along the linear path. For example, fan control knob 260 and, thus, tension member 150, may be movable to a first position, a second position, and a third position. Markings or indicators that indicate the position of fan housing 110 and/or the direction of the flow of air F at a corresponding position of fan control knob 260 and tension member 150 may be provided, e.g., on exterior 27 of microwave appliance 10 adjacent to fan control knob 260. For example, the markings or indicators may indicate that the flow of air F is being directed to recirculate, e.g., directed through first discharge port 102, while fan control knob 260 is in the first position, that the flow of air F is directed through second discharge port 104 while fan control knob 260 is in the second position, and/or that the flow of air F is directed through third discharge port 106 while fan control knob 260 is in the third position. As such, sliding the fan control knob 260 to the first position may result in the tension member 150 moving/rotating the drive wheel 118 so that the fan housing 110 is in the first position. Additionally, sliding the fan control knob 260 to the second position may result in the tension member 150 moving/rotating the drive wheel 118 so that the fan housing 110 is in the second position. Likewise, sliding the fan control knob 260 to the third position may result in the tension member 150 moving/rotating the drive wheel 118 so that the fan housing 110 is in the third position.

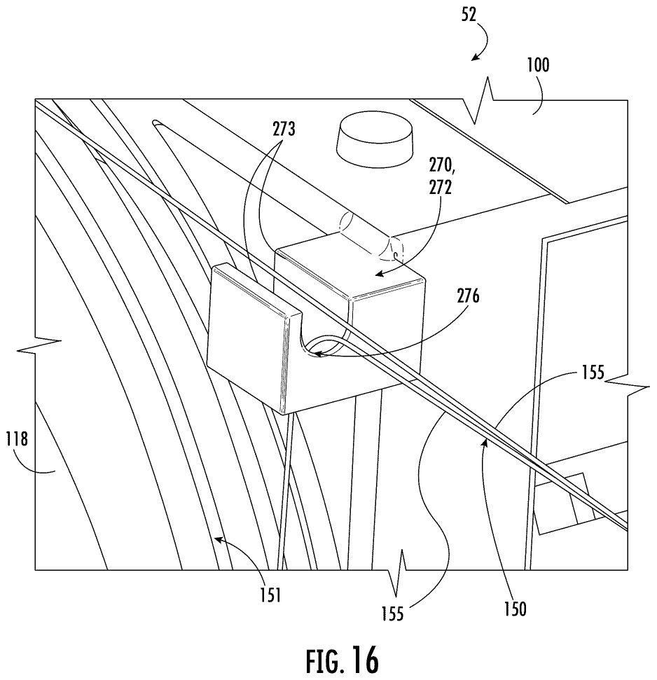

Notably, the tension member 150 may be looped through a plurality of guides 270, such as a first tension member guide 272 shown in FIG. 16 and multiple second tension member guides 274 shown in FIG. 13. The plurality of guides 270 may route the tension member 150 so that linear movement of tension member 150 is translated to rotational movement of the portion of the tension member that encircles the drive wheel 118. As such, the plurality of guides 270, particularly first tension member guide 272, permit tension member 150, e.g., a looped portion 153 thereof, to be arranged/looped circumferentially around drive wheel 118 as described above. As shown in FIG. 16, in some embodiments, first tension member guide 272 may be mounted on/to fan assembly 52, e.g., to discharge housing 100 thereof. The first tension member guide 272 may include a pair of guide walls 273 between which the tension member 150 is positioned. The pair of guide walls 273 may align the tension member 150 with a portion of the contact surface 152 of drive wheel 118, e.g., a portion of the contact surface 152 that is atop the drive wheel 118 in the vertical direction V. Additionally, first tension member guide 272 may include an arch 276. The arch 276 may define an angle, e.g., extending vertically downward at an approximately 90-degree angle, that aligns the tension member 150, e.g., the looped portion 153 thereof, with a different portion of the contact surface 152 of drive wheel 118, e.g., a portion of contact surface 152 that is on one of a front or back side of the drive wheel 118 in the transverse direction T. In this respect, first tension member guide 272 permits/guides the looped portion 153 of tension member 150 circumferentially around drive wheel 118 and facilitates alignment of tension member 150 with contact surface 152 of drive wheel 118.

Simultaneously, the plurality of guides 270, particularly second tension member guides 274 shown in FIG. 13, permit portions of tension member 150 to be linear, such as a plurality of linear portions 155, two of which are connected to the looped portion 153 as shown in FIG. 13. For example, as shown in FIG. 13, the plurality of linear portions 155 of tension member 150 may be looped through second tension member guides 274 such that a triangular shape may be defined by three of the plurality of linear portions 155 of tension member 150. Furthermore, one of the plurality of linear portions 155 of tension member 150 may be aligned, e.g., in the lateral direction L, with fan control knob 260, e.g., the notch thereof, and attached to the fan control knob 260. In this respect, movement/sliding of fan control knob 260 along the linear path as described above moves the linear portion 155 of tension member 150 attached to the fan control knob 260 along the linear path and, as such, applies a tension to and pulls/moves the linear portion 155 attached to the fan control knob 260, which rotates the drive wheel 118 in one of two rotational directions, e.g., clockwise or counterclockwise.

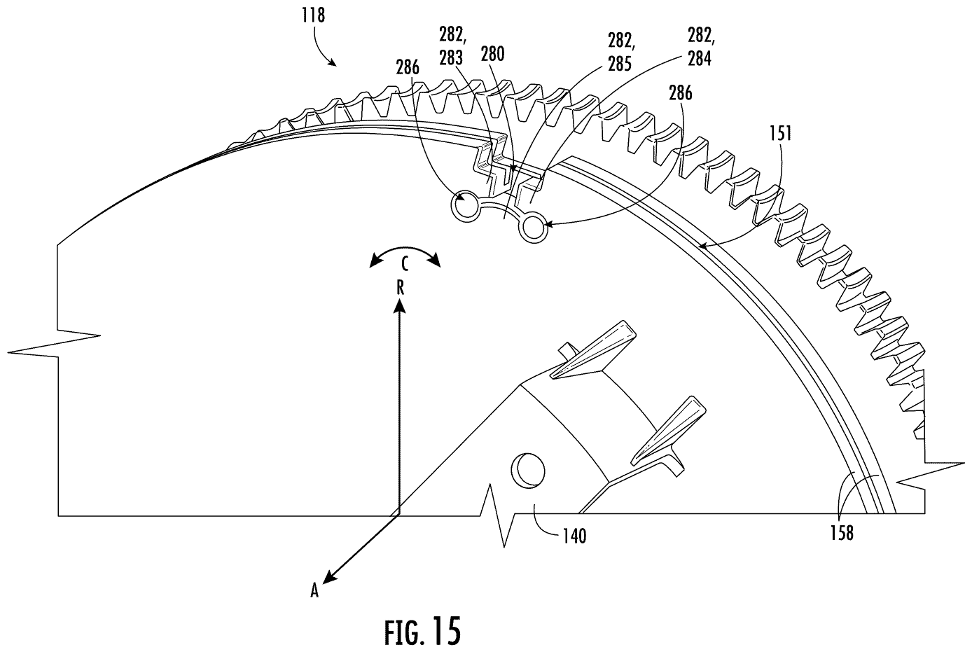

According to some example embodiments, drive wheel 118 may include a tension member retention pocket 280, which is defined through drive wheel 118. As shown in FIG. 15, the drive wheel 118 may include a plurality of tabs 282, such as three tabs 282, which may be positioned within the tension member retention pocket 280. A first tab 283 and a second tab 284 of the three tabs 282 may be spaced apart from each other along the circumferential direction C. Additionally, a third tab 285 of the three tabs 282 may be positioned below first tab 283 and second tab 284 in the radial direction R. Additionally, a plurality of sub-pockets 286, such as two sub-pockets 286, may be defined between the plurality of tabs 282. For example, one of the sub-pockets 286 may be defined between the first tab 283 and the third tab 285 while the other of the sub-pockets 286 may be defined between the second tab 284 and the third tab 285. A portion of the tension member 150 may be looped through the tension member retention pocket 280, e.g., between the plurality of tabs 282 and within the sub-pockets 286. Additionally, the plurality of tabs 282 may retain the portion of the tension member 150 that is looped through the tension member retention pocket 280 within the sub-pockets 286, thereby inhibiting the tension member 150 from slipping on/along the drive wheel 118, e.g., contact surface 152 thereof, particularly during rotation of drive wheel 118.

While described herein as moving/rotating due to manual movement of a tension member, e.g., tension member 150, it should be appreciated that drive wheel 118 may alternatively be rotated in any other suitable manner. For example, as shown in FIG. 17, in some embodiments, drive wheel 118 may additionally include a plurality of gear teeth 121, which may be circumferentially arranged or arrayed around drive wheel 118. The plurality of gear teeth 121 may engage a plurality of gear teeth or threading of a different gear, e.g., such as threading 163 of a worm gear 162. The different gear, e.g., worm gear 162, may be operatively coupled to motor 166. In this respect, worm gear 162 may be rotated by motor 166. As such, motor 166 rotates worm gear 162, worm gear 162 rotates drive wheel 118 and, thus, fan housing 110. Motor 166 may be activatable by an electronic switch easily accessible by the user of microwave appliance 10. In this respect, the user may select/choose between rotating the drive wheel 118 and, thus, the fan housing 110 by activating the motor 166 or by adjusting the fan control knob 260 as described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance, comprising:
a casing defining a cooking chamber for receipt of food items for cooking and a circulation conduit, the circulation conduit including an inlet and an outlet;
a door mounted to the casing to permit selective access to the cooking chamber;
an adjustable fan control knob positioned on an exterior of the cooking appliance; and
a fan assembly positioned within the circulation conduit, the fan assembly comprising:
a discharge housing comprising a plurality of discharge ports;
a fan housing comprising an outlet, the fan housing mounted within the discharge housing, the fan housing selectively rotatable within the discharge housing to align the outlet with a selected one of the plurality of discharge ports;
an impeller rotatably mounted within the fan housing, whereby rotation of the impeller circulates air through the outlet of the fan housing and the selected one of the plurality of discharge ports;
a drive wheel comprising a groove defined circumferentially around the drive wheel, a surface of the drive wheel positioned within the groove, the drive wheel coupled to the fan housing; and
a tension member connected between the fan control knob and the drive wheel and engaging the surface of the drive wheel, whereby adjustment of the fan control knob moves the tension member thereby rotating the drive wheel and the fan housing.

2. The cooking appliance of claim 1, the drive wheel further comprising:
a tension member retention pocket defined through the drive wheel, a plurality of tabs positioned within the tension member retention pocket.

3. The cooking appliance of claim 2, wherein:
a plurality of sub-pockets are defined between the plurality of tabs positioned within the tension member retention pocket; and
the plurality of tabs retain a portion of the tension member that is looped through the tension member retention pocket within the plurality of sub-pockets thereby inhibiting the tension member from slipping on the drive wheel.

4. The cooking appliance of claim 1, wherein:
the fan control knob is slidable along a linear path between a plurality of positions, whereby sliding of the fan control knob along the linear path moves the tension member along the linear path; and
the tension member is looped through a plurality of guides, whereby the plurality of guides translate linear movement of the tension member to rotational movement of a portion of the tension member that encircles the drive wheel.

5. The cooking appliance of claim 1, wherein the plurality of discharge ports comprises three discharge ports facing in three different directions.

6. The cooking appliance of claim 5, wherein the discharge housing is defined between a top side, a bottom side, a first side wall, a second side wall, a front side, and a back side.

7. The cooking appliance of claim 6, wherein one of the three discharge ports is positioned on the top side, one of the three discharge ports is positioned on the front side, and one of the three discharge ports is positioned on the back side.

8. The cooking appliance of claim 1, wherein:
the fan housing comprises:
a first fan housing section; and
a second fan housing section;
the impeller is a first impeller;
the fan assembly further comprises a second impeller;
the discharge housing further comprises:
a first discharge housing section, the first fan housing section and the first impeller mounted within the first discharge housing section; and
a second discharge housing section spaced apart from the first discharge housing section, the second fan housing section and the second impeller mounted within the second discharge housing section; and
the drive wheel is positioned between the first discharge housing section and the second discharge housing section.

9. A cooking appliance, comprising:
a casing defining a cooking chamber for receipt of food items for cooking and a circulation conduit, the circulation conduit including an inlet and an outlet;
a door mounted to the casing to permit selective access to the cooking chamber; and
a fan assembly positioned within the circulation conduit, the fan assembly comprising:
a discharge housing comprising a plurality of discharge ports;
a fan housing comprising an outlet, the fan housing mounted within the discharge housing, the fan housing selectively rotatable within the discharge housing to align the outlet with a selected one of the plurality of discharge ports;
an impeller rotatably mounted within the fan housing, whereby rotation of the impeller circulates air through the outlet of the fan housing and the selected one of the plurality of discharge ports;
a drive wheel comprising a surface that extends circumferentially around the drive wheel, the drive wheel coupled to the fan housing; and
a tension member engaging the surface of the drive wheel, whereby movement of the tension member rotates the drive wheel and the fan housing.

10. The cooking appliance of claim 9, the drive wheel further comprising:
a groove defined circumferentially around the drive wheel, the surface positioned within the groove.

11. The cooking appliance of claim 9, the drive wheel further comprising:
a tension member retention pocket defined through the drive wheel, a plurality of tabs positioned within the tension member retention pocket.

12. The cooking appliance of claim 11, wherein:
a plurality of sub-pockets are defined between the plurality of tabs positioned within the tension member retention pocket; and
the plurality of tabs retain a portion of the tension member that is looped through the tension member retention pocket within the plurality of sub-pockets thereby inhibiting the tension member from slipping on the drive wheel.

13. The cooking appliance of claim 9, further comprising:
an adjustable fan control knob positioned on an exterior of the cooking appliance,
wherein, the tension member is connected between the fan control knob and the drive wheel.

14. The cooking appliance of claim 13, wherein:
the fan control knob is slidable along a linear path between a plurality of positions, whereby sliding of the fan control knob along the linear path moves the tension member along the linear path; and
the tension member is looped through a plurality of guides, whereby the plurality of guides translate linear movement of the tension member to rotational movement of a portion of the tension member that encircles the drive wheel.

15. The cooking appliance of claim 9, wherein the plurality of discharge ports comprises three discharge ports facing in three different directions.

16. The cooking appliance of claim 15, wherein the discharge housing is defined between a top side, a bottom side, a first side wall, a second side wall, a front side, and a back side.

17. The cooking appliance of claim 16, wherein one of the three discharge ports is positioned on the top side, one of the three discharge ports is positioned on the front side, and one of the three discharge ports is positioned on the back side.

18. The cooking appliance of claim 9, wherein:
the fan housing comprises:
a first fan housing section; and
a second fan housing section;
the impeller is a first impeller;
the fan assembly further comprises a second impeller;
the discharge housing further comprises:
a first discharge housing section, the first fan housing section and the first impeller mounted within the first discharge housing section; and
a second discharge housing section spaced apart from the first discharge housing section, the second fan housing section and the second impeller mounted within the second discharge housing section; and
the drive wheel is positioned between the first discharge housing section and the second discharge housing section.
